(19) United States
(12) Patent Application Publication
(10) Pub. No.: US 2007/0061838 A1
(43) Pub. Date: Mar. 15, 2007

(54) METHODS AND SYSTEMS FOR DISPLAYING AUDIENCE TARGETED INFORMATION

(75) Inventors: Daniel Andrew Grubbs, Seffner, FL (US); David Schlaifer, Tampa, FL (US)

Correspondence Address: AKERMAN SENTERFITT, P.O. BOX 3188, WEST PALM BEACH, FL, 33402-3188, US

(73) Assignee: i7 CORP, Tampa, FL (US)

(21) Appl. No.: 11/466,305

(22) Filed: Aug. 22, 2006

Related U.S. Application Data
(60) Provisional application No. 60/716,228, filed on Sep. 12, 2005.

(51) Int. Cl. H04N 7/10; H04N 7/025; H04N 5/445; G06F 3/00; G06F 13/00; H04N 7/16

(52) U.S. Cl. 725/35; 725/135; 725/42; 725/43; 725/34; 725/46

(57) ABSTRACT

A media presentation method which includes identifying a display capable of presenting audio/video content, and identifying personal information for an audience at a location where the display is located. Informational content for display to the audience, such as advertising, is selected based in part upon the identified personal information so that the audience receives relevant advertising. Audio/video media productions are simultaneously presented within said display along with said informational content.

### CROSS-REFERENCE TO RELATED APPLICATIONS

This application claims the benefit of U.S. Provisional Patent Application No. 60/716,228, filed Sep. 12, 2005, the entire contents of which are incorporated by reference herein.

### BACKGROUND

1. Field of the Invention

The present invention relates to the field of media distribution and, more particularly, to presenting audience targeted information upon a media displays such as television screens.

2. Description of the Related Art

Presently, known television services display advertisements by breaking into the television show and displaying several advertisements one after the other. The advertisement breaks are annoying to viewers, which often results in viewers channel surfing during breaks, or otherwise not paying attention to the advertisements.

Cable TV operators are currently losing ground to satellite television providers, and other telecommunications companies who can now provide television in addition to telephone service, the Internet, and wireless delivery. Cable TV has over the last few years begun to enhance its services by providing digital services to allow for pay per view, telephony, high-speed Internet, and on-screen guides to create a more interactive environment. While this has stemmed the tide of losses somewhat, its competition is steadily gaining ground. Additionally, competitors are fighting over viewers whose numbers have remained largely unchanged for a decade and hence can only take share from each other.

It is desirable to enhance the services offered by Cable companies, which additionally enhances the viewer's enjoyment of television and other media programs. It is further desirable to provide targeted advertising to viewers so that the viewer may be interrupted by advertising less than at present.

### SUMMARY OF THE INVENTION

The present invention provides a media presentation method which includes identifying a display capable of presenting audio/video content, and identifying personal information for an audience at a location where the display is located. Informational content for display to the audience, such as advertising, is selected based in part upon the identified personal information so that the audience receives relevant advertising. Audio/video media productions are simultaneously presented within said display along with said informational content.

In one arrangement, the selecting step can be further based upon personal information collected during use of the display or other services provided to the audience. The personal information can include at least one of information on television programs watched on the display, websites visited, and area codes of incoming and/or outgoing telephone calls.

In another arrangement, an entity that provides the service can be permitted to specify programmatic criteria used in the selecting step. In a presently preferred arrangement, the viewing area of the display may be divided into a plurality of sectors, with the audio/video media productions displayed in at least one of the sectors, and the informational content displayed in at least one other of the sectors. Preferably, a viewing area of the audio/video media production sector is greater than a viewing area associated with of any other one of the plurality of sectors. At least one of the plurality of sectors displaying informational content can be an advertisement sector reserved for presenting advertisements obtained from a source other than a source of said audio/video media productions. The space within said advertisement sector can be sold by a broker to advertisers. Advertisers can pay for space within the advertisement sector based in part upon characteristics identified with an audience determined to be at a location where the display is located at a time a selected audio/video media production is viewed, and/or upon past audio/video media production viewing histories identified with an audience determined to be at a location where the display is located at a time a selected media production is presented. At least one of the plurality of sectors can be an information sector that presents at least one of a weather, a current time, a current date, current stock information, and current news.

A temporary sector can be established, having an area of the display less than the audio/video media production sector that overlays the audio/video media production sector for a period less than a duration of the audio/video media production presented within the audio/video media production sector. During a presentation of the audio/video media production, the temporary sector is displayed, advertisements are presented within the temporary sector, and then the temporary sector is removed.

The audio/video media productions supplied by an audio/video media source can also be modified before presentation within the display so that the audio/video media production includes a visually rendered object, which is specifically associated with a broker determined entity.

The broker determined entity can be selected from at least one of an advertiser that has paid said broker advertising revenue and an entity associated with a location where the display is located.

The selecting step can be performed within a media box communicatively linked to said display that is provided by a broker and that is communicatively linked to a computing system of the broker.

The method can further include providing an interaction means for a viewer of said display to interact with content displayed within one of said audio/video media productions. The interactive means permits the viewer to submit at least one information request. Responsive to a submitted information request, the content displayed within the associated audio/video media production can be altered to provide viewer requested information.

A viewer provides the personal information in exchange for, for example, a free or subsidized telecommunications service. A media, such as a cable or satellite TV provider or the like can gain an advantage, increase market share, and generate more revenue in premium services by providing free or subsidized television services to the consumer. This can create an effective roadblock to another provider trying to gain access to the household.

The cost of the subsidy is offset by providing extremely targeted banner and/or standard spot advertising on the television screen, which can be achieved using a segmented display. The household provides information to the cable provider to allow the cable provider to describe the profile of the individual household to an advertiser. Using set-top or in-unit technology (STB), the household can be identified and, optionally, the location in the household (living room, bedroom, child's room, etc.) with a unique identifier. The consumer is provided with fewer, more targeted advertisements, which gives an advantage that the viewer is not readily annoyed by the advertising.

The advertiser can select a group to direct messages to using various criteria. The advertiser then provides the advertising content to a broker along with the criteria. Finally, the STB can periodically, whether it is on or off, check with the advertising broker to determine if it needs to download an advertisement. If so, the advertisement is downloaded and stored for later display. At the appointed time, the display on the television is segmented, and the advertisement is displayed for the specified amount of time.

The present invention can be implemented in accordance with numerous aspects consistent with material presented herein. For example, one aspect of the present invention can include machine readable storage means for causing a machine to perform the method steps. Another aspect of the present invention can include a system for performing the method steps, including a display and means for carrying out the method.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, any other recording medium, or can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawing embodiments which are presently preferred, it being understood, however, that the invention is not limited to the precise arrangements and instrumentalities shown.

FIG. 1 is a schematic diagram of a system for presenting audience targeted information upon media displays such as television screens in accordance with an embodiment of the inventive arrangements disclosed herein.

FIG. 2 is a schematic diagram of a system for associating media productions with sectors of a display in accordance with an embodiment of the inventive arrangements disclosed herein.

FIG. 3 is an illustrate screen of a sectorized display in accordance with an embodiment of the inventive arrangements disclosed herein.

### DETAILED DESCRIPTION OF THE INVENTION

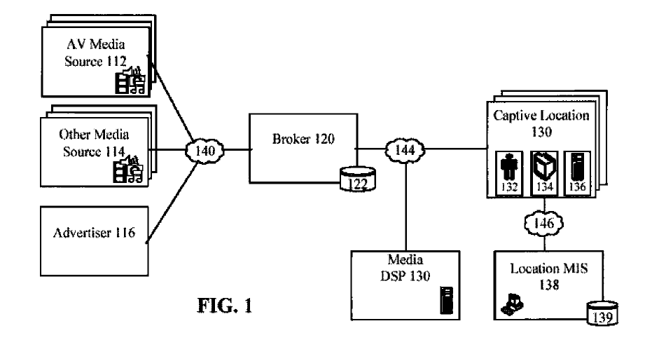

FIG. 1 is a schematic diagram of a system 100 for presenting audience targeted media information content in accordance with an embodiment of the inventive arrangements disclosed herein. The system 100 can include a location 130 having an audience 132, a display 134, and/or a media box 136. The location 130 can be linked to a location management information system (MIS) 138 via a network 146 and to a broker 120 via a network 144. A media digital signal processor 130 can also be linked to network 144. A broker 120 can be communicatively linked to an AV media source 112, another media source 114, and an advertiser 116 via network 140.

As used herein, the location 130 can be any location that includes one or more people for a duration. The location 130 can include a domestic residence, a waiting room where people gather while waiting for a desired service, a collection of roommates, a collective body using a common room (for example a college dorm), a business, or any other location where people may watch audio/video media productions. The location 130 can also include a geographical region within which people are confined, which can include both indoor and outdoor locations. For example, the location 130 can include a physician's waiting room, an airport waiting area, a den area of a house, an area viewable from line to a service station/cash register, an area along a highway along which a series of billboards are located, and the like. A captive audience 132 can include one or more people proximately positioned within or about the location 130.

The display 134 can be any device capable of presenting media productions including, but not limited to, a television, a computer monitor, a media projection device, a mobile communications device, a wearable-computing device, and similar equipment. In one embodiment, the display 134 can present streamed audio video content. In another embodiment, the display 134 can receive a file or packet containing digitally encoded content, can decode the content, and can present the decoded media production using a visual presentation means and/or an audio presentation means.

Media productions can include audio/video productions, such as movies, television shows, cartoons, broadcast sporting events, and similar programs. Media productions can also include pictures, photos, graphical content, text-based documents, icons, and logos. Additionally, media productions can include songs, speech, and other audibly presentable content. Further, media productions can include live broadcasts, previously recorded productions, and interactive productions. Interactive productions can be defined as productions permitting viewer interaction, such as live call-in shows, chat or other Internet-enabled forums, and the like.

It should be appreciated that any of a variety of technologies can be used in conjunction with presenting the media productions. In an embodiment where one of the media productions includes an interactive production, individuals of the captive audience 132 can interact with presented content of the interactive production using a short message service (SMS), a text messaging service, a transmission control protocol/Internet Protocol (TCP/IP), or other information conveyance technology.

For example, using a fixed/constant telephone number, an advertisement contained within an interactive production can include a unique code for that advertisement or a unique code for that advertisement and the captive location 130 at which the advertisement is displayed. The display 134 can conspicuously display instructions on how to send an advertisement code via a mobile phone using SMS text messaging. Responsive to sending the code, the phone user can obtain advertiser contact information, a coupon, a sweepstakes entry, and the like. Obtained information can be presented upon the display 134 and/or upon the mobile phone. The same code can be sent from the same mobile device a second time to indicate a willingness to allow an agent of the advertiser to directly contact the individual at the mobile device's number. The second sending of the code from the same mobile device can have other meaning. For example, the second (or subsequent) sending of the code can include a desire for an advertisement, a request for additional information, an agreement to purchase an advertised item, and the like.

It should be appreciated that media programs can also use the same technique for audience participation activities including voting, submitting a question, participating in a quiz show, and the like.

Media box 136 can include an electronic device communicatively linked to the display 134 that permits the presentation of selected media production within assigned sectors. Media box 136 can be a stand alone electronic device such as a set-top box (STB), can be a software device executing within a computer, can be a device integrated with display 134, and can be a device integrated into another appliance, such as a cable box, a personal video recorder, or a television gaming system.

In one embodiment, media box 136 can generate a single media stream containing multiple media productions, each presented within an assigned sector. The media stream can be generated from one or more different files and or/streams, each containing a media production. For example, media box 136 can receive a television broadcast from audio/video media source 112 via an analog media stream, can receive an advertisement audio/video production from other media source 114 via a digital media stream, can retrieve stock and weather information from Internet sources, and can access data store 122 maintained by broker 120 to obtain advertising media. After receiving the media productions, the media box 136 can assign each of these media productions to a sector of the display 134. The media box 136 can adjust the content of each media production to fit within an assigned sector. The media box 136 can then generate a signal formatted for presentation within the display 134 that includes the adjusted media content.

In another embodiment, the media box 136 can include criteria for selecting media productions. The media box 136 can use these criteria to programmatically determine which media productions from a set of available media productions are to be presented within particular sectors. In one embodiment, the criteria used by the media box 136 can include a schedule associating media productions with time slots and sectors.

In yet another embodiment, the criteria can include an explicit user selection. For example, a member of the captive audience 132 and/or captive location 130 owner can decide what media presentation is to be presented within one or more of the sectors. A remote control or a television switch can be used by the member or owner to select which media presentation is to appear within a sector of the display 134. Moreover, an option exists to move from one sector to another, allowing for a user selection of content within each sector of the display 134.

In one embodiment, the television switch can be a switch contained within a Web site. Viewers, administrators, or any authorized personnel can access the Web site via a Web browser. The user can input commands into the Web browser to select one or more media presentations for the display 134. In response, the selected media productions can appear within display 134. Additionally, the Web site can permit the scheduling of media productions within one or more of the displays 134 at user specified times.

In still another embodiment, the criteria can include a series of logical rules that permit a situational selection of media productions for different sectors. For example, the criteria can be based upon characteristics of the captive audience 132 and corresponding characteristics specified by advertisers. Comparing these characteristics can enable an advertiser to target advertising to a known audience.

Media selection criteria and rules can also be based upon media that is to be simultaneously presented in other sectors. That is, content presented within one sector can affect content that is to be presented within another sector. For example, when a television program contained within one sector is presenting media relating to beer, an advertisement for beer can be selected for presentation within another one of the sectors.

If an upstream provider, such as a network, is using the same technology, they can pass or add a code to the signal when their own secondary message is being displayed. For example, if a soda manufacturer wants to display a banner advertisement in one of the sectors during an episode of a popular comedy without using targeted advertising to specific viewers, the network can add a pop-up message during the show. In order to stop the medial unit 136 from showing another secondary advertisement in another sector of the display, or another fill screen advertisement, a signal can be added with a code indicating that a primary advertisement or message is being displayed. The media unit 136 can add this to its logic when selecting media to display.

Information pertaining to the characteristics of the captive audience 132 and/or content being presented in sectors can be obtained from one or more external sources, one such source being a broker 120. Another external source can include a location management information system (MIS) 138. As used herein, MIS 138 can be any system that contains information about the captive location 130, the captive audience 132, and/or people within the captive audience 132. The MIS 138 can include or be communicatively linked to a customer relationship management system (CRMS).

For example, when the captive location 130 is a physician's waiting room, a physician's intake system (part of MIS 138) can provide information of which patients are actually present within the captive location 130. Additionally, the physician's MIS 138 can also include substantial personal information for each patient within the waiting room. The media box 136 can receive this information and select media productions for sectors accordingly.

For instance, if one of the patients in the captive location 130 is suffering from allergies as recorded by MIS 138, the media box 136 can receive this information, and can responsively select an advertisement for an allergy medication to be presented in one of the sectors. It should be appreciated that because the media box 136 is configured to perform its selections automatically based upon programmatically established criteria, privacy information from the MIS 138 used by media box 136 is not disclosed to any third party and confidentiality of the information can be maintained.

Media digital signal processor (DSP) 130 can be a computing device capable of performing digital signal processing operations against media productions. For example, media DSP 130 can be utilized by the media box 136 to convert media productions from an initial format into a format capable of fitting within an assigned sector. In one embodiment, broker 120 can utilize media DPS 130 to modify media content obtained from media source 112 or 114 in accordance with advertiser 116 goals. For instance, a sign included within a movie can advertise PRODUCT A. Broker 120 can use media DSP 130 to modify the in-movie advertisement to advertise PRODUCT B instead.

It should be appreciated that Media DSP 130 can utilize any variety of known techniques in the art to perform DSP functions on audio, images, and video. Processing of media productions can require manual manipulations by skilled technicians or can be an automated process.

For example, optical character recognition technologies can be used to optically recognize text presented within images and/or video and speech recognition technologies can be used to speech recognize utterances within audio. Additionally, a closed-caption feed or other type of feed can be scanned to obtain “recognized text”. Recognized text can be compared against an established list (such as product names). Each item in the list can be associated with a replacement text, which can be substituted within the media stream (using audio processing techniques in the case of audio substitutions and graphical processing techniques in the case of visual substitutions).

In such a manner, a spoken product name appearing in a media production can be automatically substituted with a different spoken product name. Similarly, visually presented products shown in a media production, such as a container of DRINK A, can be substituted with a different product, such as a container of DRINK B. Operations performed by the Media DSP 130 can occur in a time delayed fashion or can occur in real time or in near-real time.

Networks 140, 144, and 146 can represent any communication mechanism capable of conveying analog or digitally encoded information. Each of the networks 140, 144, and 146 can include a telephony network like a public switched telephone network (PSTN), a mobile telephone network, a computer network, a cable network, a satellite network, a broadcast network, and the like. Further, each of the networks 140, 144, and 146 can use wireless as well as line-based communication pathways.

Digitally encoded information can be conveyed via network 140, 144, and 146 in accordance with any communication protocol, such as a packet-based communication protocol or a circuit-based communication protocol. Additionally, information conveyance across networks 140, 144, and 146 can occur in an open or secured fashion. For example, communications over networks 140, 144, and 146 can use Secured Socket Layer (SSL) connections, can use private/public key encryption techniques, and can utilize Virtual Private Network (VPN) technologies.

In operation, a broker 120 can control the presentation of content via displays 134 located within multiple captive locations 130. The broker 120 can obtain media productions from at least one audio/video media source 112 as well as from other media sources 114. The obtained media productions can be presented within defined sectors of one or more displays 134 at one or more captive locations 130. A media box 136 can be used to control the presentation of media content within the defined sectors. A media digital signal processor 130 can be used to modify media productions supplied by media sources 112 and 114.

Broker 120 can sell sectorized advertising space within display 134 to one or more advertisers 116. An advertiser 116 purchasing space can be allowed to present advertiser-specific content upon the display 136. The purchased advertising space can include space within a sector of the display 134.

In one embodiment, advertising space can be sold based in part upon characteristics of audience 132 of the captive location 130. The characteristics can be general characteristics for an audience expected to be in the captive location 130 or can be characteristics associated with individuals determined to be located at the captive location 130 as further described below. For example, individual specific characteristics can be obtained from data store 139 associated with location management information system 138.

It should be appreciated that the arrangements shown in FIG. 1 are for illustrative purposes only and that the invention is not limited in this regard. The functionality attributable to the various components can be combined or separated in different manners than those illustrated herein.

In one contemplated embodiment, for example, system 100 can operate without a media box 136. In the embodiment, a server from a centralized location, such as from a location local to broker 120, can construct at least one display presentation signal, which includes multiple sectorized media productions, and convey the constructed signal to multiple displays 134 in a display targeted fashion. Displays 134 can be targeted based upon a uniquely identified IP address, MAC address, site key number, or some other identifier. Displays 134 can also receive multiple media streams (each stream including a complete set of sectorized media productions) sent from the centralized server, can select one of these streams using filtering criteria local to the display 134, and can present media contained within the selected stream.

In another contemplated embodiment, the broker 120 need not be a separate entity from the audio/video media sources 112, the other media source 114, and/or advertiser 116. Similarly, the media sources 112 and 114 need not be separate entities from advertiser 116. For example, the broker 120 can advertise space for sale within display 134, at which point the broker 120 operates as both advertiser 116 and broker 120. Broker 120 can also present broker-created media programs within one or more sectors of display 134, which would allow broker 120 to be a media source, such as media source 112 or 114. Similarly, media source 112 can choose to advertise one or more programs, which would allow media source 112 to operate as both a media source and as advertiser 116.

FIG. 2 is a schematic diagram of a system 200 for associating media productions with sectors of a display in accordance with an embodiment of the inventive arrangements disclosed herein. In system 200, broker 210 can provide multiple media productions 212 to media box 220. A portion of these media productions can be stored in data store 220 accessible to media box 220 to be utilized when needed.

The media box 220 can include a schedule table 224 that establishes criteria for presenting media within display sections at particular times. In one embodiment, the schedule table can be generated or configured by broker 210. The schedule table 224 can be also automatically generated by the media box 220 based upon established media program selection criteria and selection rules.

Schedule table 224 can include columns for media, time, and sector. For example, media A can be associated with a time of 9:00 to 9:30 and can be associated with sector 234. Only one media program can be associated with a particular sector for a designated time. Different media, however, can be associated with different sectors. For example, media C can be associated with sector 232 and a time of 9:10 to 10:00.

One or more additional tables can be used in cooperation with the schedule table 224. For example, an available media table (not shown) can list, for a time slot, one or more available media presentations. Within the available media table, media D, E, F, G, H, and I can be associated with time slot 9:00 to 9:30 and with sector 236. The media box 220 can select media programs from the available media table to generate entries of the schedule table. For example, media D and E can be selected from the available media table, resulting in media D being assigned time 9:14 to 9:16 for sector 236 in the schedule table and media E being assigned time 9:18 to 9:26.

In one embodiment, when no media is associated with a sector for a given time, a default media program, such as a blank screen area or a logo presentation, can be provided for that sector. Alternatively, a fall back media presentation can be assigned to the sector for the unassigned duration. In a particular embodiment, advertisers can receive a discounted rate for advertising media within unassigned sectors. In another embodiment, when one sector is unassigned for a significant duration (defined as a duration exceeding a previously established threshold), the sectorized display can be dynamically readjusted to remove the unassigned sector, thereby expanding the viewing space of non-removed sectors.

The media box 220 can construct an audio/video stream 226 that contains media content formatted in accordance with the schedule table 224. The display 230 can render the audio/video stream. The display 230 can include sector 232, 234, and 236.

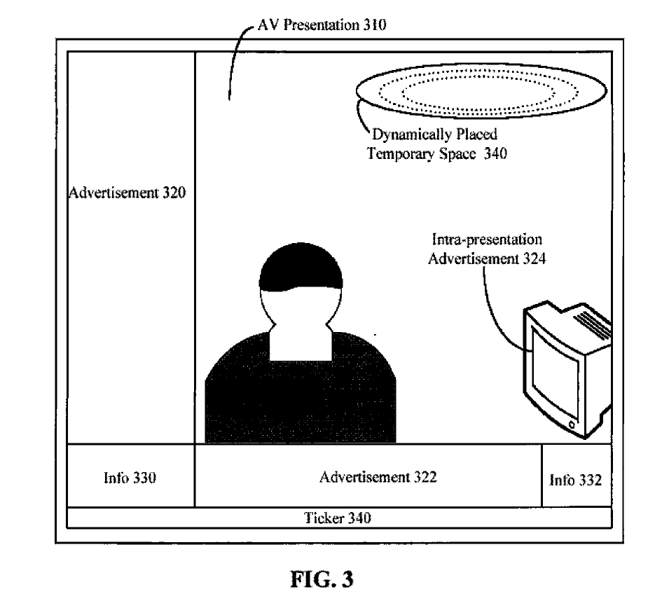

FIG. 3 is an illustrative screen 300 of a sectorized display in accordance with an embodiment of the inventive arrangements disclosed herein. Screen 300 can be presented in the context of any display having sectorized content, such as display 134 or 230.

Screen 300 illustrates an audio/video presentation sector 310, advertisement sectors 320 and 322, information sectors 330 and 332, and ticker sector 340. Audio/video presentation sector 310 can be reserved for presenting an audio/video media production provided by an audio/video media source. The audio/video media source can commercially distribute said audio/video media production so that the media production is able to be presented upon non-sectorized displays. That is, sector 310 can display commercially available broadcasts and movies.

Because the audio/video presentation sector 310 can attract the attention of an audience and be of primary interest to the audience, a viewing area allocated to sector 310 can be greater than any other viewing area within screen 300. Additionally, sound emitting from a device including screen 300 can be obtained from an audio/video media production presented within the audio/video presentation sector 310.

Advertisement sectors 320 and 322 can be sectors reserved for presenting advertisements, which can be paid for by advertisers. Unlike conventional advertisements, the advertisements presented within advertisement sector 320 and 322 can be obtained from a separate source that provides content for audio video presentation sector 310. For example, the separate source can be an Internet source, a data storage source, or a different broadcast source. Additionally, because the advertisements presented within sectors 320 and 322 are not being broadcast in a traditional fashion, content presented in sectors 320 and 322 need not be approved by authorities associated with traditional broadcasts. Instead, different rules, which may or may not be established by the same authorities that are responsible for traditional broadcasts, can apply to content presented in accordance with method 300.

Information sectors 330 and 332 can be reserved for presenting information including, but not limited to, weather, a current time, a current date, current stock information, and current news. Content within information sectors 330 and 332 can be customized for the location where the screen 300 is being presented. So that if the presentation occurs within Miami, Fla., weather and time for Miami, Fla. are presented therein.

One or more of information sectors 330 and 332 can present information in a rotating fashion. That is, content presented within information sectors 330 and 332 can be time divided into different segments. Thus, within a single information sector, a weather time segment can be preceded by a news segment, which can be proceeded by a time of day segment, and so forth.

The ticker sector 340 can be reserved for presenting text-based information in a scrolling fashion. For example, the ticker can be a stock ticker, a sports score ticker, a news ticker, and the like. The ticker section 340 is not limited to textual content, and graphical and video elements can also be included. For instance, each stock displayed within a stock ticker is often preceded by icon of an up or a down arrow.

Although sections 310, 320, 322, 330, 332, and 340 can be implemented in a stationary and static fashion, the invention is not limited in this regard. In one embodiment, the viewing areas of one or more of the sectors can be dynamically adjusted and/or removed. For example, advertisement sector 320 can be dynamically removed from screen 300 resulting in a width of audio/video presentation section 310 being expanded. Additionally, sectors designed to be non-statically positioned are contemplated.

Dynamically placed temporary space 350 is one such sector. Space 350 can be placed on top of sector 310, obscuring a portion of media content that would otherwise be viewable. Space 350 can be assigned to a media production in the same manner that other sectors can be assigned. Unlike other sectors, however, space 350 can appear upon screen 300 (zoom in), can present an assigned media production, and can disappear (zoom out).

Additionally, space 350 as shown in screen 300 illustrates that dynamic spaces and/or sectors are not limited to rectangular viewing areas, but can instead be an area having any two or three dimensional shape, such as an oval, sphere, polygon, tetrahedron, star, and the like.

Intra-presentation advertisement 324 can be a special sector that is presented within audio/video presentation 310. Unlike dynamically placed temporary space 350, which overlays media within sector 310, intra-presentation advertisement 324 is integrated with the content of sector 310. Placing content within intra-presentation advertisement 324 can require that digital signal processing operations be performed upon the media production that it is integrated within.

In one example, a television set can appear within the media content of sector 310. The media content originally shown in the television set can be replaced with customized content. While any content replacement can occur, intra-presentation advertisement 324 is typically used to unobtrusively substitute items within a movie or television program with advertiser specified items.

To use the system described above in the method of the invention, a consumer must first be provided with the system, which requires the collection of initial information. In order to provide initial basic information, the consumer is asked to fill out a form to provide information to create a profile, or the information can be collected by voice, electronic means, by mail, in person, via facsimile, or by proxy through an agent. This information can become the basis of their Subscriber Profile keyed by a Subscriber ID. The information can include:

Primary Name (First, Middle Initial, & Last).

Address.

For the primary user:
a. Gender.
b. Date of Birth.
c. Race.
d. Occupation.

Number of Additional Persons in the Household:
a. Adult Males (list ages).
b. Adult Females (list ages).
c. Minor Males.
d. Minor Females.

Number of dogs in household.

Number of cats in household.

Number of other common pets.

The initial information that can form the viewer's household or location profile may include additional or alternative information from that given above, which is merely an exemplary list. Once the initial information has been received, a service provider can provide, for example, the television services, internet services, and telephony services using VoIP (Voice Over Internet Protocol), radio over IP, TV over IP and any other media over IP. Any other digital media delivery or other platform may also be used for the transmission of media to the household. The service provider will maintain the lines of transmission, and will provide the customer service and support that is commonly associated with these types of services.

On initial installation of the system, an installer, if there is one, can add additional information about the location of the building or home where the viewing part of the system is being installed. For example, the installer can record the ID of a media box 136 being installed in the master bedroom of a home, which can be relevant for determining viewing habits and types of advertisements. The installer can collect additional information such as an address verification, verification of demographics of the household based upon observation, the number of potential media boxes or other base units that could be installed in the building or home, and can add additional persons who were not included on the initial application form. If the system is installed by the end user, such additional information could be collected by providing a printed form, an on-screen menu to setup and provide the information, or through other electronic means.

The information is typically stored in media box 136, and in the broker data store 122. The broker data store 122 is connected to the media box 136 or other base unit via a connection from the service provider, which will typically be a television display cable that is commonly found in many homes. Alternatively, the connection may be a fiber optic line, a plain old telephone system (POTS), a digital subscriber line (DSL), a T1 connection, or any other transmission line or wireless connection.

By uniquely identifying a household or location such as a waiting room, observing its habits, and using that to send highly targeted, relevant advertising back into the household or location, the service provider can provide a reduction in the advertising the consumers see. The advertising can be provided in the sectorized display so that it is present at the same time as media content being watched by the consumer, or the advertisement can be presented in a break in the media content. The advertising that the consumer does see is more relevant to their lifestyle, which means that the advertising is then useful to the consumer, as someone who is potentially genuinely interested in the product offering.

After the initial service has been set up, the consumer's daily habits can be observed, and a more detailed profile on the household can be built up. The habits that can be observed, if given sufficient permission by the consumer, can include but is not limited to:

Television viewing habits;

Television on times (when are they home);

Content of the television episode using closed captioning or data brokers;

Internet sites visited;

Telephone numbers called;

Incoming telephone numbers; and

Keywords contained within emails or telephone conversations.

The system can note TV channel changes on the television display, and can track those changes. To reduce the amount of data, the system can be set to only track channels that are displayed for more than a fixed number of seconds. If it is desired to capture every channel change, that information can be collected as a “channel surf”. By combining a “channel surf” with other temporal, environmental, and profile information, the service provider can begin to determine what causes a surf action. The base unit can transmit the channel change information by sending the media box's ID information, the time, and the channel number or frequency to the service provider. The service provider can transmit that information to the data store located at a central server.

The service provider can also provide on a regular basis a programming schedule. This can be later cross-referenced with the service provider, date and time, and channel or frequency to locate the particular content or show being viewed.

By monitoring the closed captioning text that is being transmitted with the signal, messages can be triggered to be displayed upon the mention of certain key words or phrases mentioned during a show. Files can be pushed from the data store through the service provider to the base unit to store key words or phrases to watch for on that particular base unit. If there is a match with the closed captioning, then the base unit can either display a locally cached (in the base unit) message or advertisement immediately or contact the data store through the service provider to transmit the message and display it upon receipt.

The base unit can also record when the base unit is turned on and turned off. At the time of each on or off change, a packet can be sent with the base unit identifier, time, and whether it was changing from an off to an on or on to an off status. Additionally, in the case of power failures, the unit can transmit a packet of information on initial boot up. This can give the service provider one more piece of information about the consumer regarding quality of electrical power at the location.

The base unit can also be equipped with environmental sensors. This includes a temperature gauge and a humidity sensor. This information, combined with external weather data for the geographic location where the base unit is installed, can be used to determine if there is air conditioning in the home, energy habits of the consumer, and the presence of people in the room. This information can be compiled into a packet of information sent out at fixed intervals on a constant or intermittent basis.

By equipping the base unit with motion sensors, it will be able to determine if there is movement in front of the base unit. Movement indicates the presence of viewers. Motion information can be sent on a fixed or intermittent interval. It can also be sent when the unit is on with no motion changing to a status of indicating motion or vice-versa. Motion sensors can be augmented with localized small form factor radar systems. This includes the use of ultra-wideband technology which has the capability of providing short range, precise radar systems. Using these sensors with other sensors, the base unit may be able to count the number of people in front of the display at any given point. If the service provider is able to count the number of people in front of a display, then triggers can be implemented by advertisers to display messages immediately once the count exceeds or is less than the threshold designated by the advertiser, the message can be displayed.

The base unit can also monitor the ambient volume in the room as an indicator of how many people are present. Using wave pattern matching, the base unit can compare the audio signal of the content with the ambient noise in the room. By matching the audio signal with the ambient noise, it can determine the volume (decibel level) of the display unit. This can be an indicator of many things including, but not limited to, number of people in the room, ability to hear, ambient noise outside the house (e.g. a house under a flight path may constantly adjust the volume), and it can also indicate if there are others sleeping in a residence.

The system can further track the URL of every page visited by the consumer using the high-speed Internet service provided. This information is collected by the service providers routers or servers and a shadow copy of the URL is sent to the data store along with the consumer's unique identifier.

By providing telephony services, the system can monitor the telephone numbers coming into and out of the consumer's location. The service provider can send a packet to the data store including telephone number, incoming or outgoing, date and time, and the consumer's identifier. Additionally, the service provider can record the start of the call and the end of the call to determine importance. In this scenario, the service provider is sending the same packet as before, but is adding an indicator identifying the beginning and ending of the telephone call. The telephone number can either be sent as a whole number or in pieces as Country Code, Area Code, Prefix (if applicable), and remaining number. This can be dependent upon the capabilities of the service provider.

The telephone number, once captured at the data store, can be cross referenced with a third party or internal database that stores the business classification of the number if there is a match on reverse lookup. The telephone number, if sent as a whole, can be parsed to country code, area code, prefix (if applicable), and remaining number. The number can be additionally checked to determine if it is a business or residential telephone number. It is envisioned that the reverse lookup may require access to international telephone directories.

An additional point of data collection is the customer service web page of the service provider. The consumer will be able to update their profile information or provide more detailed information about themselves. This can be used to provide the consumer with an even better targeted advertising experience. The service providers' web sites can transmit this information to the central data store on a periodic basis. Customer service representatives can collect the additional information from the consumer over the telephone as well. This information can be transmitted to the central data store periodically.

Third parties can be enlisted to enhance the quality of the data collected. This can include content providers providing detailed synopses of episodes, such as frame markers, time indexes, or embedded electronic markers in the content to indicate when a described action is to take place. For example, a television episode can have the main character ride away on a motorcycle three minutes and 25 seconds into the episode. Using the temporal information in the synopsis or a marker in the content, a motorcycle manufacturer could display a message listing a local dealership to contact regarding the motorcycle being viewed on the screen. Content creators (studios) can be encouraged to provide information about the products being placed in shows. This can allow for content creators to benefit from the sale through an envisioned revenue sharing model. It can also allow for the content creators to measure which products sell well during particular shows. The data store can provide aggregate information on purchases to the content creators to help them in negotiating terms with the companies who place products. The data store can also provide similar aggregates based on content types to companies wishing to do product placements.

Additional third party information can include weather data. The system can collect localized weather conditions including temperature and precipitation. This includes both future forecasts as well as current conditions.

Yet a further source of third party information is personal data providers. This can include credit reporting agencies, mailing list companies, and consumer information databases. By cross referencing their data in either real time or in batch collections, the value of the data store can be enhanced with additional specific and personal information. Other additional data sources include crime statistics from local law enforcement agencies, collective purchasing habits of a geographic area, motor vehicle registration information cross referenced by address, moon phases, financial indices, Amber alerts, sunrise and sunset times, traffic conditions, book purchases using a popular web vendor's database of buying habits, local sports wins and losses, and gas prices. This is not intended to be an exhaustive list of sources, but it is used to illustrate that using the base profile opens the opportunity to collect more information. Using national aggregators or government services, the system can distribute Amber alerts, public health messages, severe weather warnings, or other public service announcements to the base units for display. Consumers can control the types of announcements they see on their display by using the web interface, onscreen guide or other means provided by the service provider.

The sectorized display 300 is designed to work independently of the content display. This can allow for the base unit to control and manipulate the secondary sector(s) content. To that end, the delivery of content can occur in a method that is most conducive to the current operating procedure of the service provider. In the case of a television service provider, this means that content can be sent to the base unit as is currently done by sending all frequencies all of the time. However, this could also include content delivery using Internet Protocol (IP or IPTV) on a show by show basis. It can allow for satellite transmission into the location, over the air radio transmissions, line of sight laser transmissions, microwave technology transmissions, other wire based and other non-wire based transmission methods.

Content can be stored in the base unit using a digital video recorder (DVR) using a magnetic storage device, optical storage device, holographic storage device, or another electronic storage device. This allows for content to be stored and later displayed. The content can retain its descriptive information provided by the content creator or third parties as described above. This will allow for the secondary messages to remain relevant to the show or primary content being displayed. For example, a comedy show recorded on a Tuesday, but displayed later on a Thursday, can be matched with secondary messages that, among other things, will be relevant to the content and that the day is now Thursday. The display of the primary content and all secondary displays can be handled by the base unit to transmit the signal from the base unit to the display unit. Flexibility can be added to the base unit to work with a wide variety of display units.

Due to the large amounts of data that will be sent to the data store, the use of queuing mechanisms to capture the incoming data is proposed. The data store can have a capture location where all information packets can be sent. An information packet is described as a collection of data in a format that is understood by the receiving end and not to be confused with an internet data packet. The information will be sent to the data store and kept in a folder or database. More than one queue can be used to prioritize the packets. A secondary process, the Harvester, can collect the information in its respective bin. High priority bins will be worked first. High priority bins include purchases, information requests, and sudden changes in passive monitoring data that is being requested by an advertiser. Another definition of high priority data is information that needs to be processed as quickly as possible since there is a consumer waiting for action. The Harvester can read each packet and determine the appropriate database to store the information. The information can then be written to the database. At this point, the database management system (DBMS) can take over to create redundancy and scalability.

Data updates can happen constantly and simultaneously with data retrieval processes. In order to accomplish this, the data store can comprise multiple computers running in parallel or collectively. Data retrieval requests can be sent to a group of computers that have the majority of data a seeker is looking for and with the lowest current workload. On a regular basis, for example nightly, the system can aggregate the most common demographics to create reports that can be quickly accessed by advertisers and other data miners. Third party data sources can be given electronic data interchange information. This includes EDI, flat files, and XML transfers. Large amounts of data may be transferred in a compressed mutually compatible format.

Using the information generated by the system to improve the profile of the household, a service provider can provide highly relevant and targeted advertising wanted by both the advertiser and, surprisingly, by the consumer. The following example gives more details on the method employed in providing the present invention.

### EXAMPLE 1

The Smith household has signed up with AG Cable Co. for free basic cable television service, unlimited domestic telephone service for $9.99 per month, an additional box for $1 per month, and high-speed Internet service for another $9.99 per month. During the application process, Mr. Smith provided information about the household which he attested to be correct. This information included: he is 53 years old, his wife is 51, he has a son of 14, a daughter of 17, and they have 1 dog. In order to verify his identity, he provided his driver's license number. This was required information.

The application form also asked him some optional questions which was clearly stated as optional. It was also clearly stated that providing this information reduced the likelihood of his family seeing irrelevant advertising. So, Mr. Smith provided that he was an accountant, they had 2 foreign cars, owned their residence, and commuted 15 miles to work every day. The application had a clearly and plainly written privacy policy that stated that information can be collected through many means by monitoring his family's usage of the service.

AG Cable Co sends out a technician to install the equipment. The installer notes that one box is going into the living room and the other is installed in the master bedroom. The installer notes the unique ID of each box and its installation location on the installation form. He connects the family's cordless telephone base unit to the box. Finally, he installs the high-speed Internet modem in the den. Again, he records the unique ID of the modem.

The information from the application process and the installation is consolidated and filed. A base profile is created for the Smith household. An initial advertising schedule is created based on this information.

After installation, Mr. Smith begins to watch his favorite evening show on one of the cable news channels. At this point in time, the service provider knows that it is likely either Mr. or Mrs. Smith is watching the TV based on the known demographics of the program. The service provider also knows the time of day, and the date, for example that it is 9 pm and close to bedtime, and that it is January, just after the holidays. The broker selects a home refinance advertisement based on the profile, selects the highest bidder, transmits the advertisement, and the first slide-up ad is displayed on the TV screen. Before the TV is switched off, a high-end sedan advertisement is displayed and a commercial for a small resort in Hawaii. The TV service has been interrupted only three times during two hours of viewing

Meanwhile, Mrs. Smith is using the newly installed high-speed Internet service. She visits, among other sites, a home-decorating site, a large home improvement retailer site, and a site about bathroom fixtures. This information is collected by broker. The broker adds this information to the profile. The next night the Smiths are shown another advertisement for low rate home refinancing this time with a small image inviting them to press the blue B button on their remote to have more information e-mailed to the e-mail account on file. Another advertisement displays the latest from a high-end, but little known, faucet company with a new line of modem basins and faucets. The same can be done by sending a short message to the consumer's listed mobile device. If there is more than one mobile device in a household, then the consumer will be prompted as to which device to send it to. If the consumer is purchasing content for a mobile device, then the information is sent to the mobile content provider and then sent to the consumer's device.

Later in the month, as the profile begins to grow, the service provider can observe that the household is watching travel related programs, they are visiting websites related to travel, are looking at hotel sites for resorts in Hawaii, and have made calls to toll-free telephone numbers related to resorts in Hawaii. Additionally, weather information collected for their zip code indicates low temperatures and periodic snow. This convergence of information allows the service provider to provide advertising by large and small resorts in Hawaii, airlines, travel insurance, and credit cards throughout the evening. By controlling costs, the service provider can allow small resort operators to pay small amounts within their budget but reach highly interested, ready to purchase, consumers.

Finally, not only can the service provider observe the information actively being sought by the consumer, but they can also observe the information that is generated by the incoming telephone numbers. For example, households with out-of-town relatives can be identified by observing incoming area codes and prefixes. That information can be translated into specific messages that include advertisements that mention flights to a specific city near their relatives. Alternatively, known toll-free numbers can be observed to see who is competing to contact the household. This can include an increase in credit-card solicitors which could be an indicator of credit risk. This can also include bill collectors to change the ads to display refinancing or consolidators. Any telephone number that can be reversed and narrowed down to a specific industry can be used as information to increase the relevancy and usefulness of the advertising.

One aspect of the present invention is the sale of the information to create a targeted advertisement slot. This can be accomplished using a comprehensive web site that can allow the advertiser to create a profile of the type of consumer they are trying to reach. After a profile is created, the advertiser can then use that to create budgets for purchase and activate the purchase. A profile can include all of the information captured directly from the consumer, all of the passive information collected by the base unit, and information from third party sources. This should include all of the information captured as described above. Once a profile is created, the advertiser will be able to set a price per impression. This price may or may not be displayed alongside other similar profiles that to create an auction system. This can allow advertisers to increase their chances of being displayed. The profile can be broken down to consumer demographics (geographic, economic, gender, age, etc.) as one group, content matching, environmental factors and then all other. As the profile is built, the system may or may not show how their selections compare in each group to another advertiser trying to reach the same group. For example, if an advertiser simply picks 18-25 year old males in Florida, then the system can display what another advertiser has set as their maximum price per impression for that spot. In another example, an advertiser simply may want to run their advertisement during a particular program. The data store can balance the bulk of the advertisers to maximize both the needs of maximizing revenue and creating benefit to the most advertisers. It can be set to attempt to not allow lock outs of smaller advertisers.

Advertisers can set daily budgets for the maximum amount to spend. This allows smaller advertisers to participate in the advertising, which is difficult for them to do in traditional TV advertising. A billing system can created to bill in advance of the advertisements being run.

Large and small advertisers can select from a list of templates provided by the service provider to create their advertisement if they desire. This makes it easier for companies without production departments to create their message and put it into distribution as quickly as possible. A template form guides the advertiser through the creation process. This can include uploading any images relevant to the advertisement. There may fields for displaying a telephone, company name, web site address, or simple directions. There could be steps for including messages for each slide in the message. For example, a thirty second ad could have two slides to display ad copy and a third showing more information. Additionally, the template creation process can have an opportunity to create a bounce back e-mail and mobile phone message. This is the message sent to the consumer if they select the appropriate button on the remote control. There can be a buy now link to provide fields that are needed to complete a transaction. There could be an option to include text to send back to the consumer via SMS mobile text messaging to a mobile device. Additionally, the template can allow for a list of locations to be uploaded for the company. The advertisement can then insert the appropriate nearest location including address, directions, and/or telephone number for a consumer to call if there is. By indicating on a checkbox or some type of flag during the advertisement build process that he wants to do closest match to the site, when the advertisement is displayed it can show the closest contact or location. During any interactive selection, such as purchasing a pizza, the purchase information can be routed using that list to the correct location.

The advertiser begins the process by signing up for the service. This is an on-line process started by collecting company information, billing information, and other general information that may be needed to create an account. The advertiser will not need to interact with a person to complete the setup. Once entered and accepted into the system, the advertiser will gain access to the rest of the advertising sales portal.

An advertiser can then create a campaign to define an advertisement or a collection of ads. A campaign is a collection of ads, there may be more than one, a budget, and the criteria used to put the ad in rotation. The actual advertisement content can be shared amongst multiple campaigns. An advertiser will select the criteria it is looking for in order to define a target audience. This criteria can be any of the information collected by the system, any third party information that is made available in the system, or information the advertiser has provided itself. With regard to the information provided by the advertiser, this could include for example a mailing list to match against.

The system can collate the information against the data known to it as supplied by the various sources and parties described above. The advertising wizard or process may prompt the advertiser to provide additional criteria to clarify a selection. It can then take the criteria defined, and create a prediction of the number of impressions or slots that are available for sale as well as the amount that others are bidding for the same or similar criteria. This prediction is made with the notation that the ad will only be shown when the criteria selected by the advertiser is met. Thus, the prediction is only an indicator, the ads may be shown sooner or later than originally predicted. Additional interactive material can be collected by the system if the advertiser proceeds. This includes whether or not to include informational requests, ability to purchase an item on screen, send an SMS message, and the like. If any of the interactive items are selected, the advertiser will need to provide the content and information needed to fulfill such requests. This includes the text of any of SMS or email messages. If there is a purchase available to be made by the consumer on screen, the advertiser will need to set up a remittance process.

Using the predictions generated by the system, the advertiser can set up a budget. The budget is set by the advertiser stating how much it is will to pay for each impression for the campaign created. Again, by showing the advertiser how much others are bidding for a similar set of criteria, the system is helping the advertiser achieve the maximum reach and frequency desired. The advertiser can later change the daily budget or the amount per impression to pay.

The advertisement will be submitted to a review process to review the ad for content. At present, it is envisioned that a qualified representative of the broker will review the advertisement for content. They will primarily be reviewing it for offensive, objectionable, questionable, or illegal content. Once approved for content, the ad will be submitted to the rotation system.

The system will enter the ads into the rotation system. This is the process for determining which displays the ad will be shown on. The rotation system is primarily a queue system with indicators of displays that it can be shown on and other criteria. When a display contacts the rotation system to get a new ad or schedule, it can identify the unit number and the other environmental factors as identified by the base unit or display at that time. The request will be made for an ad, and the rotation system pick an ad from the queue and deliver it. The ad will be downloaded to the base unit. Once displayed, the base unit can report back to the rotation system that an impression was made and billed accordingly.

Post display, the advertiser can gather data on ad display and compare that with other data gathered by the system at the time the ad was displayed. This is an important reporting process that allows the advertiser to maximize the impact of a particular ad or campaign. For example, if they want to increase the reach and frequency a particular ad, then they can compare it to the success and failure of competing ads in the system. The reports can be made available online, via e-mail, through SMS messaging, facsimile, or printed reports. The advertiser will be able to modify its selections and budget accordingly.

Advertisers can log into the web site or using another means to gather real-time or near real-time data on clickthroughs, on-screen purchases, requests for information, or other interaction with the advertisement. This can allow an advertiser to compare the number of impressions to the number of interactions taken by the consumer. The advertiser may then decide to modify the advertisement or the distribution in order to change the level of interaction. Additional selection criteria for advertisers can include tying their advertisement or message to a particular public service announcement. An example is once a severe weather alert is issued, display an advertisement for storm shutters.

Advertisers can use a web based portal including an advertising “wizard” to create a media slot purchase. Ads will be sold as slots and impressions. An advertiser can define the market it is after, select from a wide range of demographics collected, keyword criteria, environmental factors, and any of the other information collected by the system. Using this information, the system will return a predicted number of slots that the advertisement will be displayed in. The predictive nature of the system is the basis of the advertising sale.

It should be appreciated that the examples given above are illustrative only, and that different types of information may be collected, different types of hardware or software may be used, and that the advertising may be provided to the household in different forms. Additionally, the invention is not restricted to use in domestic households, but may also be employed in public areas such as airport waiting lounges, bars, doctors waiting rooms, and the like.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A media presentation method comprising the steps of:
identifying a display capable of presenting audio/video content;
identifying personal information for an audience at a location where the display is located;
selecting informational content for display to the audience, the selecting step being based in part upon the identified personal information; and
simultaneously presenting audio/video media productions within said display along with said informational content.

2. The media presentation method of claim 1, wherein said selecting step is further based upon personal information collected during use of the display or other services provided to the audience.

3. The media presentation method of claim 2, wherein said personal information comprises at least one of information on television programs watched on the display, websites visited, and area codes of incoming and/or outgoing telephone calls.

4. The media presentation method of claim 1, further comprising:
permitting an entity that provides said service to specify programmatic criteria used in said selecting step.

5. The media presentation method of claim 1, further comprising:
dividing a viewing area of said display into a plurality of sectors, with said audio/video media productions displayed in at least one of said sectors, and said informational content displayed in at least one other of said sectors.

6. The media presentation method of claim 5, wherein a viewing area of the audio/video media production sector is greater than a viewing area associated with of any other one of the plurality of sectors.

7. The media presentation method of claim 5, wherein at least one of the plurality of sectors displaying informational content is an advertisement sector reserved for presenting advertisements obtained from a source other than a source of said audio/video media productions.

8. The media presentation method of claim 7, wherein space within said advertisement sector is sold by a broker to advertisers.

9. The media presentation method of claim 8, wherein said advertisers pay for space within said advertisement sector based in part upon characteristics identified with an audience determined to be at a location where the display is located at a time a selected audio/video media production is presented.

10. The media presentation method of claim 8, wherein said advertisers pay for space within said advertisement sector based in part upon past audio/video media production viewing histories identified with an audience determined to be at a location where the display is located at a time a selected media production is presented.

12. The media presentation method of claim 7, wherein at least one of the plurality of sectors is an information sector that presents at least one of a weather, a current time, a current date, current stock information, and current news.

13. The media presentation method of claim 5, further comprising the step of:
establishing a temporary sector having an area of the display less than the audio/video media production sector that overlays said audio/video media production sector for a period less than a duration of the audio/video media production presented within the audio/video media production sector, wherein during a presentation of the audio/video media production, the temporary sectors is displayed, advertisements are presented within the temporary sector, and then the temporary sector is removed.

14. The media presentation method of claim 1, further comprising the step of:
modifying the audio/video media productions supplied by an audio/video media source before presentation within the display so that the audio/video media production includes a visually rendered object, which is specifically associated with a broker determined entity.

15. The media presentation method of claim 14, wherein the broker determined entity is selected from at least one of an advertiser that has paid said broker advertising revenue and an entity associated with a location where the display is located.

16. The media presentation method of claim 1, wherein said selecting step is performed within a media box communicatively linked to said display that is provided by a broker and that is communicatively linked to a computing system of the broker.

17. The media presentation method of claim 1, further comprising:
providing an interaction means for a viewer of said display to interact with content displayed within one of said audio/video media productions, wherein the interactive means permits said viewer to submit at least one information request; and
responsive to a submitted information request, altering the content displayed within the associated audio/video media production to provide viewer requested information.

18. A machine readable storage, having stored thereon a computer program having a plurality of code sections executable by a machine for causing the machine to perform the steps of:
identifying a display capable of presenting audio/video content;
identifying personal information for an audience at a location where the display is located;
selecting informational content for display to the audience, the selecting step being based in part upon the identified personal information; and
simultaneously presenting audio/video media productions within said display along with said informational content.
